(19) United States
(12) Patent Application Publication
(10) Pub. No.: US 2014/0344295 A1
(43) Pub. Date: Nov. 20, 2014

(54) MESSAGE BASED WEB CONTENT RETRIEVAL SYSTEMS AND COMPUTER IMPLEMENTED METHODS THERETO

(71) Applicants: Michael Shungkai Lam, Milpitas, CA (US); Ihab Hamadeh, Sunnyvale, CA (US)

(72) Inventors: Michael Shungkai Lam, Milpitas, CA (US); Ihab Hamadeh, Sunnyvale, CA (US)

(21) Appl. No.: 14/446,750

(22) Filed: Jul. 30, 2014

(51) Int. Cl. G06F 17/30

(52) U.S. Cl. CPC G06F 17/30861
USPC 707/754

(57) ABSTRACT

Message based web content retrieval systems and methods are presented herein. In preferred embodiments, a method comprises receiving a request for digital content from a client device. The content may be retrieved from the content provider. Content contained in a signature pattern may be extracted from the retrieved content of the content provider to provide filtered content. Hyperlinks, images, videos, and other non-text based digital content in the filtered content may be assigned a short code string unique to the non-text based digital content from the content provider requested by the client device.

### FIELD OF THE INVENTION

The present invention relates to the field of information retrieval. More specifically, the invention relates to web content retrieval and transmission systems for electronic devices which may not have access to a web browser or the internet.

### BACKGROUND

The amount of information on the internet is constantly growing. A user interested in information on a single subject may be inundated with results upon performing a web search on that subject. Additionally, in order to view and access information on a webpage or website, an electronic device such as a desktop computer, laptop computer, tablet computer, smartphone, and other similar electronic devices comprising a web browser and stable internet connection must be used. A web browser allows a user to view information from a webpage on the display screen of the device and to interact with the webpage to access additional information.

Without a web browser and stable internet connection, an electronic device is typically unable to send, receive, or otherwise access webpage information or web content. Electronic devices without web browsers include cellular “feature” phones. While these feature phones may comprise the necessary hardware and software required to run a web browser, the browsing experience tends to be quite poor. For this reason users of feature phones have typically been uninterested or unable to send, receive, or otherwise access webpage information.

Traditionally, in order to access webpages on an electronic device, the device must comprise a web browser and it must have access to a network connection for the receipt and transmission of data. These network connections require a data connection that may be accessed through a cellular network data connection or a local area network connection. Without access to a data connection, web browsers are unable to send, receive, or otherwise access webpage information.

One method that attempts to access website information without the need for a network data connection or a web browser equipped electronic device comprises the use of short messaging service (SMS) text messages. Using this method, a user sends a text message to a service with a request for information for a particular website and the service sends a reply text message comprising some information from the website. Since SMS messages are typically limited to 160 characters or less, the user and the service is severely limited by the amount and type of information that may be sent, received, or otherwise accessed from a website. This information is limited to small amounts of information such as specific daily weather information, a specific stock quote for a specific time, and very narrow news information and any other small amounts of information that does not contain any images. Additionally, other information relevant to the small amount of information returned cannot be accessed except by a steady stream of multiple sent and received SMS messages.

Therefore, a need exists for novel systems and methods for the retrieval of information from webpages, websites, and other digital content sources. There also exists a need for novel information retrieval systems and methods which are able to send, receive, or otherwise access webpage information on an electronic device that does not comprise a web browser. There is a further need for novel information retrieval systems and methods which are able to send, receive, or otherwise access webpage information on an electronic device that does not have a network data connection. Finally, there exists a need for novel information retrieval systems and methods that are able to send, receive, or otherwise access webpage information on an electronic device in a manner that functions without the size and content restrictions imposed by short messaging service text messages.

### BRIEF SUMMARY OF THE INVENTION

It is one aspect of the present invention to provide novel systems and methods for the retrieval of information from webpages, websites, and other digital content addresses.

Another object of the present invention is to provide web browsing services and systems to send, receive, or otherwise access webpage information on electronic devices that do not contain a web browser.

An additional object of the present invention is to provide web browsing services and systems which are able to send, receive, or otherwise access webpage information on electronic devices that do not have a network data connection or access to the internet.

It is a further object of the present invention to provide message based web content retrieval systems and methods that are able to send, receive, or otherwise access webpage information on an electronic device without the size and content restrictions imposed by short messaging service text messages.

In preferred embodiments, the system comprises: a request Polling engine that may be configured to receive requests for digital content by a client device, wherein the request may comprise a web page or content address and optionally a short code string representing a hyperlink, image, video, or other non-text based digital content; a web content retrieval engine that may be configured to retrieve the requested content from a content provider; a signature based scrubbing engine that may be configured to extract content contained in a signature pattern from the retrieved content of the content provider to provide filtered content; a hyperlink association module that may be configured to associate or assign a short code string unique to each hyperlink contained the digital content in the filtered content requested by a client device; an image association module that may be configured to associate or assign a short code string unique to each image, video, and other non-text based digital content in the filtered content requested by the client device; and a web content converter module that may be configured to substitute the respective unique short code string for every occurrence of respective each hyperlink, image, video, and other non-text based digital content in the filtered content and to send the filtered content which may comprise short code strings to the requesting client device.

According to one aspect consistent with the principles of the invention, a method for text message based web browsing services is provided. In preferred embodiments, the method may include receiving a request for digital content from a client device. The content may be retrieved from the content provider. Content contained in a signature pattern may be extracted from the retrieved content of the content provider to provide filtered content. Hyperlinks, images, videos, and other non-text based digital content in the filtered content may be assigned a short code string unique to the hyperlinks and non-text based digital content from the content provider requested by the client device. The short code string may be substituted for its respective short code string in the filtered digital content and be used to represent the non-text based content in future requests for digital content from that client device. The filtered content comprising short code strings may then be transmitted to the requesting client device.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 shows an illustrative example of some of the components and computer implemented methods which may be found in a system according to various embodiments described herein.

FIG. 2 illustrates a block diagram showing an example of a server which may be used by the system as described in various embodiments herein.

FIG. 3 depicts a block diagram illustrating an example of a client device which may be used by the system as described in various embodiments herein.

FIG. 4 shows an example of some of the modules and engines which may be found in a system according to various embodiments described herein.

FIG. 5 illustrates an example of a signature lookup table which may be used to index content sources with one or more signature patterns according to various embodiments described herein.

FIG. 6 depicts a flow chart that illustrates an example of a computer implemented method of a message based web browsing system according to various embodiments described herein.

FIG. 7 depicts a flow chart that illustrates an example of a computer implemented method of a message based web browsing system according to various embodiments described herein.

FIG. 8 depicts a flow chart that illustrates an example of a computer implemented method of a message based web browsing system according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

### DEFINITIONS

As used herein, the term “computer” refers to a machine, apparatus, or device that is capable of accepting and performing logic operations from software code. The term “software”, “software code” or “computer software” refers to any set of instructions operable to cause a computer to perform an operation. Software code may be operated on by a “rules engine” or processor. Thus, the methods and systems of the present invention may be performed by a computer based on instructions received by computer software.

The term “client device” or sometime “electronic device” or just “device” as used herein is a type of computer generally operated by a person. In some preferred embodiments, a client device is a feature cell phone that is not capable of accessing webpages through a web browser, or other devices comprising a cellular network connection without a data connection or a wifi connetion. Non-limiting examples of client devices include; personal computers (PCs), workstations, laptops, tablet PCs including the iPad, cell phones including iOS phones made by Apple Inc., Android OS phones, Microsoft OS phones, Blackberry phones, or generally any electronic device capable of running computer software and displaying information to a user. Certain types of client devices which are portable and easily carried by a person from one location to another may sometimes be referred to as a “mobile device” or “portable device”. Some non-limiting examples of mobile devices include; cell phones, smart phones, tablet computers, laptop computers, wearable computers such as watches, Google Glasses, etc. and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the terms “data network”, “cloud”, or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include wifi and cellular networks.

As used herein, the term “database” shall generally mean a digital collection of data or information. The present invention uses novel methods and processes to store, link, and modify information such as hyperlinks, digital images and videos, other digital content, and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

As used herein, the term “digital content” or “content” shall generally include a digital collection of data or information that may be contained on a webpage, website, or other similar content address. This data or information may include perceived (rendered) information such as Textual information, with diverse render variations; Non-textual information such as Static images which may be raster graphics, typically GIF, JPEG or PNG; or vector formats such as SVG or Flash; Animated images which typically include Animated GIF and SVG, but also may be Flash, Shockwave, or Java applet; Audio, which may include typically MP3, ogg or various proprietary formats; Video, such as WMV (Windows), RM (RealMedia), FLV (Flash Video), MPG, MOV (QuickTime); Interactive information and interactive media such as “on page” interaction, Interactive text such as DHTML, Interactive illustrations ranging from “click to play” images to games, typically using script orchestration, Flash, Java applets, SVG, or Shockwave, Buttons such as forms providing alternative interface, typically for use with script orchestration and DHTML; “between pages” interaction such as Hyperlinks and standard “change page” reactivity, Forms for providing more interaction with the server and server-side databases; and Internal (hidden) information such as Comments, Linked Files through Hyperlink (Like DOC, XLS, PDF, etc.), Metadata with semantic meta-information, Charset information, Document Type Definition (DTD), etc., Diagramation and style information: information about rendered items (like image size attributes) and visual specifications, as Cascading Style Sheets (CSS), and Scripts, usually JavaScript, complement interactivity and functionality.

The present disclosure is to be considered as an exemplification of the invention, and is not intended to limit the invention to the specific embodiments illustrated by the figures or description below.

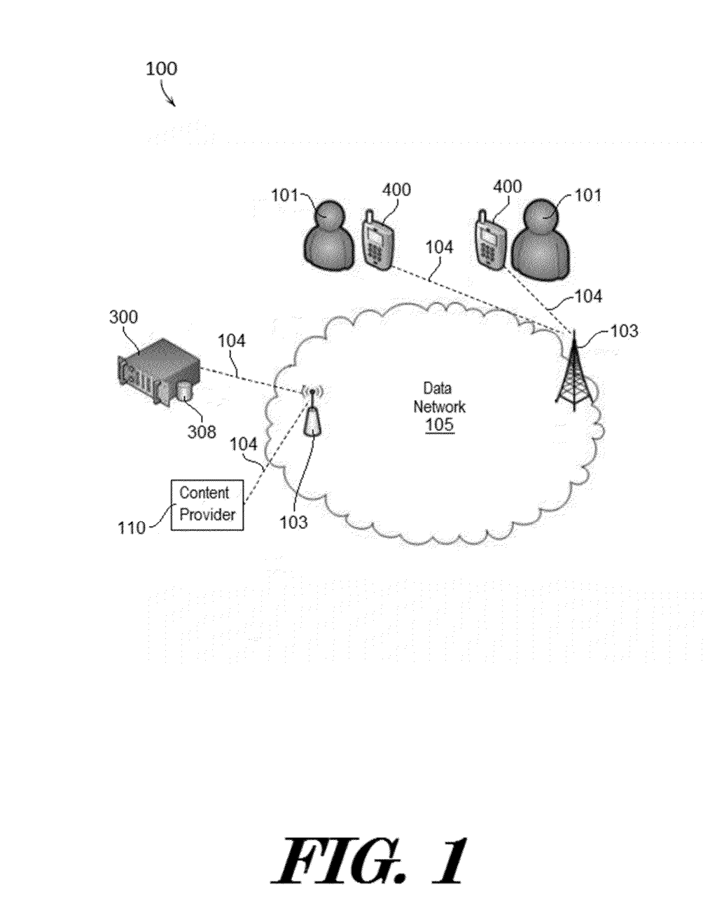

As perhaps best shown by FIG. 1, an illustrative example of some of the physical components which may comprise a message based web content retrieval system, “the system” 100, according to some preferred embodiments is presented. In this example, the system 100 comprises at least one client device 400 (but preferably more than two client devices 400) configured to be operated by one or more users 101. In preferred embodiments, at least one client device is a cellular phone device 400 capable of sending messages (e.g. mms messages) over a cellular network to one or more servers 300 with access to one or more content providers 110 over a data network 105. A client device 400 may send and receive data through a network link 104 to one or more wireless transmitters 103. Generally speaking, content providers 110 provide digital content that is accessible through the URL address or internet address of a webpage, website, or other similar content address.

The system 100 is configured to facilitate the transfer of data and information between one or more client devices 400 and servers 300 over a data network 105 and to one or more databases on a data store 308 accessible by a server 300. The data and information may include digital content from web pages and services such as CNN.com, News.Yahoo.com, Weather.com, Gmail.com, Uspto.gov, or any other suitable webpage, website, or other digital content address.

In preferred embodiments, the system 100 facilitates the transfer of data between client devices such as mobile devices 400 and machines through one or more servers 300 running in the cloud or data network 105. As used herein the term “cloud” shall generally refer to a physical location that is not the same location as a user 101 or machine, but is accessible to the user's device 400 or machine 400 through a data network 105. By way of example, data storage and processes performed by servers operated by Amazon Web Services (AWS) or other hosting providers shall be considered to be “in the cloud”.

The transfer of data to the client devices 400 may be transmitted over any data network 105 but preferably over a cellular network and ultimately to the internet where it is transferred to a server 300 which may be connected to a data store 308. The data store 308 may comprise a physical location that an electronic database may be stored in. Cellular networks may be implemented based on a number of possible different standards. For some non-limiting examples, current day cellular networks may include GSM (Global System for Mobile Communications), UMTS (Universal Mobile Telecommunications System), CDMA (Code Division Multiple Access), or LTE (Long Term Evolution) based-network, or the like. In some preferred embodiments, cellular networks do not include wifi networks that are typically found in residences (e.g. residential wifi) and at businesses such as coffee shops and the like. The term “wireless” in “wireless network” may refer to the wireless interface between network access points and client devices 400. In general, components within cellular networks may be connected using wired or wireless connections. Cellular networks may connect to other networks, such as packet networks and telephone networks.

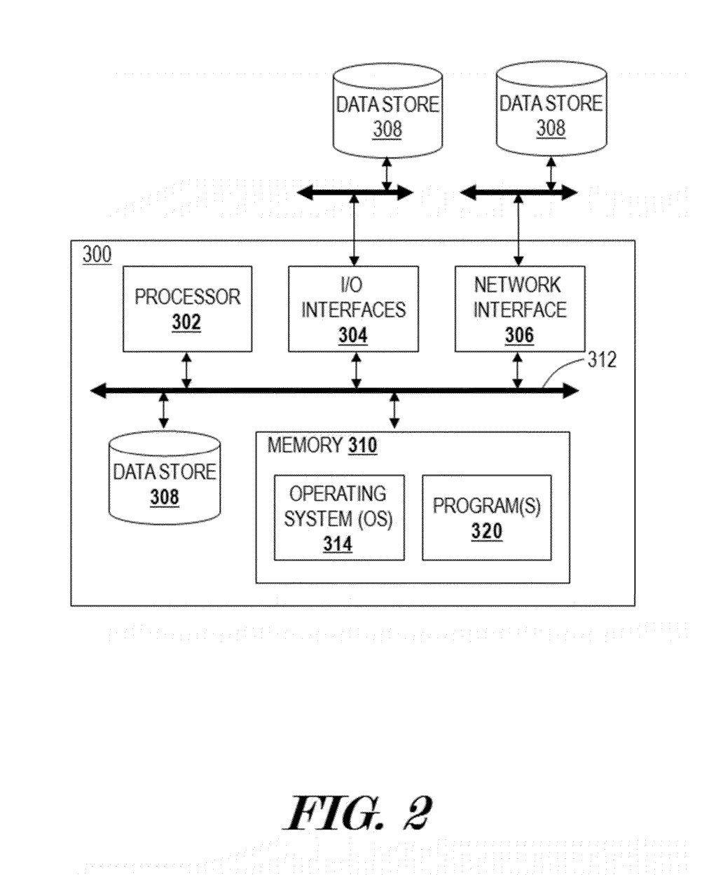

Still referring to FIG. 1, in preferred embodiments, the system 100 is configured to facilitate the transfer of information between a client device 400 and a data store 308 (FIG. 2) which may be connected to a server 300 and to a content provider 110. The data store 308 may be accessible through a content address such as a webpage or website that is maintained on a server 300 and may be accessed through a data connection or cellular network connection. The system 100 allows a client device 400 that does not comprise a web browser or internet access to access a web page or web site that is maintained on a server 300 through a network connection without using a web browser. The system 100 is configured to remove and filter content from a web page and to send the filtered content to the user's 101 client device 400.

Referring now to FIG. 2, in an exemplary embodiment, a block diagram illustrates a server 300 of which one or more may be used in the system 100 or standalone. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (0/S) 314 and one or more programs 320. The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows Server 2003/2008 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 320 may be configured to implement the various processes, algorithms, methods, techniques, etc. described herein.

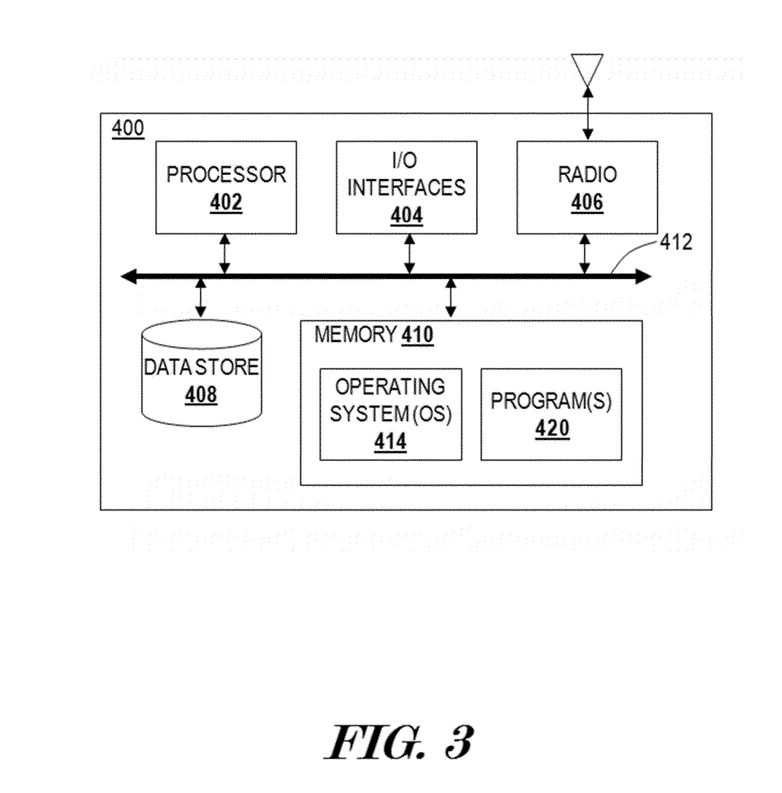

Referring to FIG. 3, in an exemplary embodiment, a block diagram illustrates a client device 400 of which one or more may be used in the system 100 or the like. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications. The I/O interfaces 404 can be used to receive images through a camera 500 and user input from and/or for providing system output. User input can be provided via, for example, a keypad, a touch screen, a scroll ball, a scroll bar, buttons, bar code scanner, voice recognition, eye gesture, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may further include an imaging device, i.e. camera 500, video camera, etc.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

In some preferred embodiments, the client device 400 includes a global positioning system sensor configured to receive latitude and longitude coordinates from satellites (i.e. a GPS signal).

In some other preferred embodiments, the client device 400 includes an accelerometer configured to receive user initiated actions (e.g. shaking the device, moving the device in a pattern, etc.).

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 3, the software in the memory system 410 includes a suitable operating system (O/S) 414 and programs 420. The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network such as the system 100.

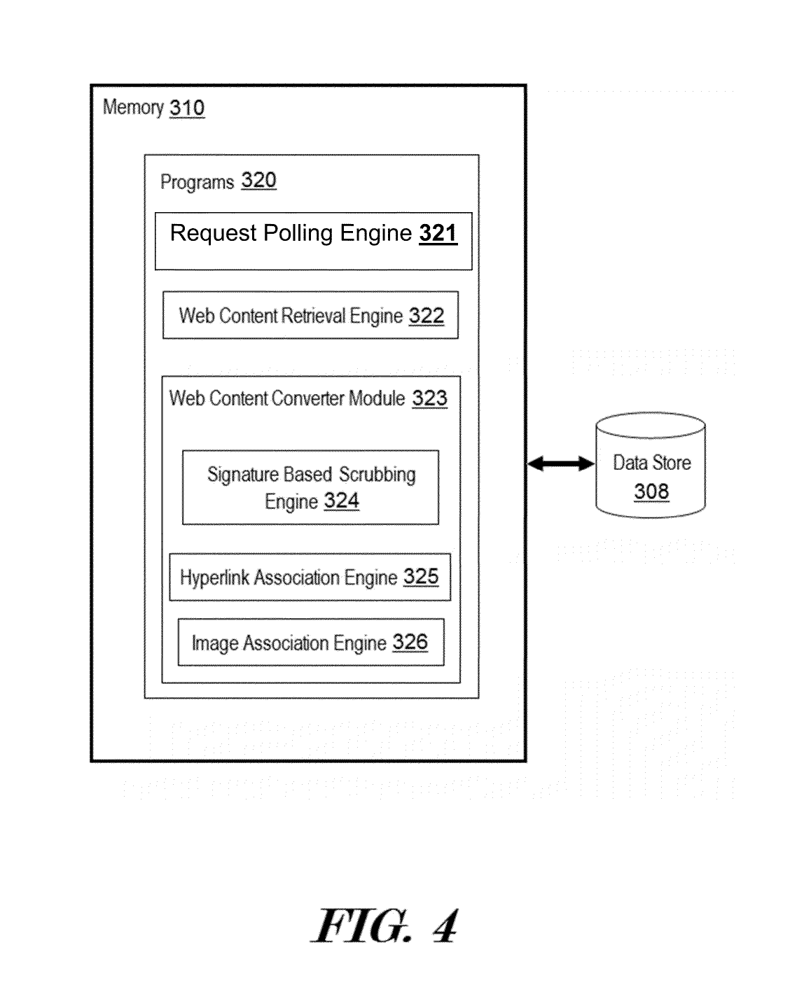

FIG. 4 illustrates an example of some of the computer implemented modules and engines which may comprise some of the programs 320 stored in the memory 310 of a server 300 (FIGS. 1 and 2) found in a system 100 (FIG. 1) according to various embodiments. In some alternative embodiments, one or more client devices 400 (FIGS. 1 and 3) may be configured to run one or more programs 320. In preferred embodiments, the programs 320 may include a Request Polling Engine 321, a Web Content Retrieval Engine 322, a Web Content Converter Module 323, a Signature Based Scrubbing Engine 324, a Hyperlink Association Engine 325, and/or an Image Association Engine 326. In some embodiments, a Hyperlink Association Engine 325 may perform some or all of the functions or processes of an Image Association Engine 326. In other embodiments, an Image Association Engine 326 may perform some or all of the functions or processes of a Hyperlink Association Engine 325. One or more of the programs 320 are able to store, send, retrieve, and otherwise edit data, preferably stored in a database on a data store 308.

The Request Polling Engine 321 program may be configured to receive requests for web content from a client device 400 (FIGS. 1 and 3) through their respective network link 104 (FIG. 1) to a server 300 (FIGS. 1 and 2) in the data network 105 (FIG. 1) such as a cellular network. The Request Polling Engine 321 may repeatedly check for or receive requests from client devices 400 sent by email, text message, or multimedia (mms) message that may comprise identification of a web page and a client device identification. In preferred embodiments, the Request Polling Engine 321 may check for requests from client device 400 sent by text message (SMS), and multimedia message (MMS), which may be converted by the cellular service carriers into email. For example, when a client device 400 sends a mobile message to an email address the message may be converted to an email to arrive at a server (300) or computer to be preferably processed by the Request Polling Engine 321. The requests from client devices 400 may comprise, a webpage address, webpage name, other similar content address and optionally one or more short code strings. In some embodiments, the Request Polling Engine 321 may direct the Web Page Retrieval Engine 322 to retrieve content from the content address requested by the client device 400. In Further embodiments, the Request Polling Engine 321 may retrieve, from a database stored on a data store 308, a hyperlink, image file, video file, audio file, or other digital content associated with a short code string in the request from the client device 400 and then direct the Web Page Retrieval Engine 322 to retrieve content from the content address associated with the short code string.

The Request Polling Engine 321 may send data for further processing to a Web Page Retrieval Engine 322. In preferred embodiments, the data may comprise a client device identification such as a cellular phone number, email address, login id, phone serial no., or other identification data unique to a client device and the web page that the client device is requesting. In further embodiments, the data may also comprise one or more short code strings. The web page or web content address that a client device is requesting may be identified in a request by a URL address of a web page, a domain name of a web page, or any other web page or content address identification that is contained in the request. In some embodiments, the Request Polling Engine 321 may be configured to store a client device identification and the web page address requested by the respective client device in a database on a data store 308 accessible by the Request Polling Engine 321, the Web Content Retrieval Engine 322, the Web Content Converter Module 323, the Signature Based Scrubbing Engine 324, the Hyperlink Association Engine 325, and/or the Image Association Engine 326. In other embodiments, the Request Polling Engine 321 may be configured to send, or otherwise make available, a client device identification and the web page address requested by the respective client device 400 to the Web Content Retrieval Engine 322, the Web Content Converter Module 323, the Signature Based Scrubbing Engine 324, the Hyperlink Association Engine 325, and/or the Image Association Engine 326.

The Web Content Retrieval Engine 322 may be configured to receive data from another engine or module, or to retrieve data from a database comprising a web page address or other web page identifying information and to download digital content from the web page or other content address which may be located on a different server 300. The digital content may be maintained and made available by a content provider 110, and may include text, images, videos, audio recordings, hyperlinks, and any other type of digital content through a network link 104 from a server 300 in the data network 105. In some embodiments, downloaded or retrieved digital content from a web page and/or the client device identification of the client device 400 that requested digital content from the webpage may be sent or otherwise made available to the Web Content Converter Module 323, the Request Polling Engine 321, the Signature Based Scrubbing Engine 324, the Hyperlink Association Engine 325, and/or the Image Association Engine 326. In other embodiments, retrieved digital content from a web page and/or the client device identification of the client device 400 that requested the webpage may be stored in a database on a data store 308 accessible by the Request Polling Engine 321, the Web Content Retrieval Engine 322, the Web Content Converter Module 323, the Signature Based Scrubbing Engine 324, the Hyperlink Association Engine 325, and/or the Image Association Engine 326.

Additionally, the Web Content Retrieval Engine 322 may be configured to retrieve or download digital content from a web page or other content address that is associated with a short code string for a particular client device 400. In some embodiments, once a request for digital content comprising a short code string is received by the Request Polling Engine 321 from a particular client device 400, the Request Polling Engine 321 may be configured to send the client device identification, the short code string, and or the website that is associated with the short code string to the Web Content Retrieval Engine 322. The Web Content Retrieval Engine 322 may then retrieve or download digital content from a web page or other web content address that is associated with the short code string for the particular client device 400.

In other embodiments, once a request for digital content comprising a short code string is received by the Request Polling Engine 321 from a particular client device, the Request Polling Engine 321 may be configured to send the client device identification, the short code string, and or the website that is associated with the short code string to a database maintained on a data store 308 that is accessible to the Web Content Retrieval Engine 322. The Web Content Retrieval Engine 322 may then retrieve or download digital content from a web page or other web content address that is associated with the short code string for the particular client device 400. The downloaded and retrieved content may be stored in permanent or temporary memory 310 on the server 300.

In preferred embodiments, the system 100 may comprise a Web Content Converter Module 323 which may have access to a database on a data store 308 to facilitate data transfer and access between a Signature Based Scrubbing Engine 324, a Hyperlink Association Engine 325, and/or an Image Association Engine 326. In alternative embodiments, one or more of the Signature Based Scrubbing Engine 324, Hyperlink Association Engine 325, and/or Image Association Engine 326 may be configured to operate in the system 100 independent from the Web Page Converter Module 323.

The Signature Based Scrubbing Engine 324 may be configured to receive data from another engine or module, or to retrieve data from a database on a data store 308 comprising digital content from a web page or other content address. The Signature Based Scrubbing Engine 324 may then filter the retrieved content from the web page or content address to remove content not contained in the content signature location of the web page thereby creating filtered content.

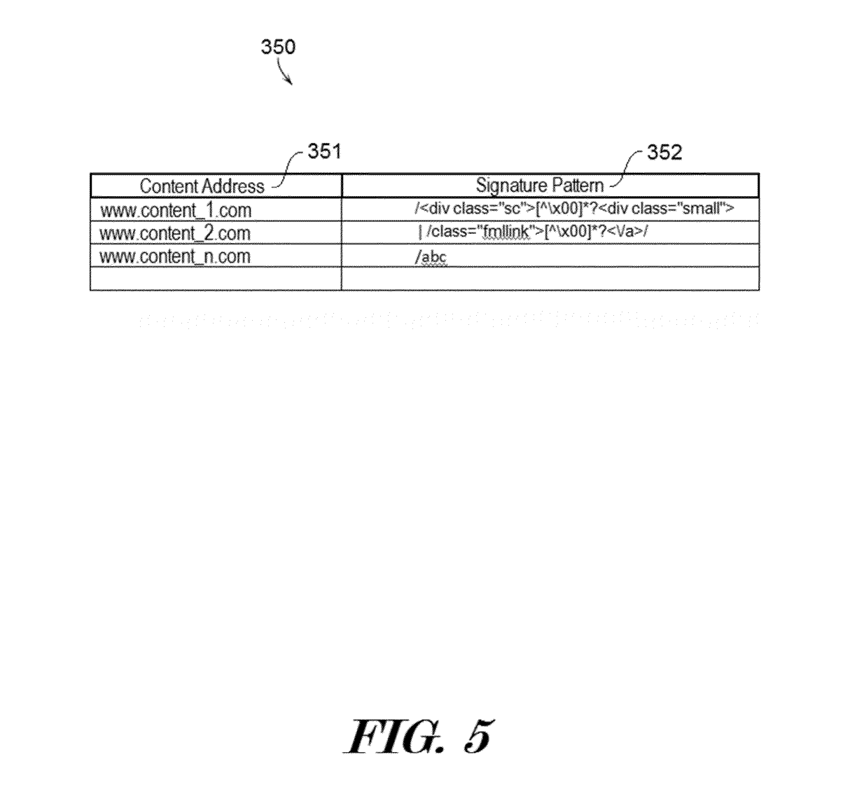

In some embodiments, the Signature Based Scrubbing Engine 324 may receive retrieved content from a requested content source such as a web page or content address from a Web Content Retrieval Engine 322. In other embodiments, the Signature Based Scrubbing Engine 324 may retrieve from a database or otherwise access retrieved content from a requested web page or content address. The retrieved content may then be compared to a signature pattern for the requested web page or content address also known as a content source. The content source may comprise one or more signature patterns which correspond to elements on a web page or content address. One or more signature patterns and content sources may be stored in a database on a data store 308 and optionally in a signature lookup table 350 (FIG. 5) that is accessible by the Signature Based Scrubbing Engine 324. Signature patterns may be written in regular expression comprising a very common pattern description language, available as a feature in many computer languages, including PHP, Perl, JavaScript, and the like. Common web page HTML tags such as div class=, class, or other tags can be expressed in regular expression signature patterns and can be plugged or inserted into a computer language to perform filtering. HTML tags may be used to mark or indicate what are the uses of different parts of a web page. For instance, the tag <p> means the beginning of a new paragraph, while the tag <b> means the beginning of bolding content. Signature patterns may include HTML tags such as div class=, class=, or any other script or language that is commonly found on similar content sources across a domain. Digital content not contained within a signature pattern of the content signature for the respective web page or digital content address may be removed or purged from the retrieved content. Similarly, digital content contained in a signature pattern of the content signature for the respective web page or digital content address may be extracted from the retrieved content. Once the retrieved content has been filtered to remove digital content not contained in a signature pattern of a content signature, or once the retrieved content has been filtered to only include extracted digital content contained in a signature pattern of a content signature, the remaining retrieved content may be referred to as “filtered content”. In preferred embodiments, the filtered content may comprise text without any formatting, images, videos, and/or audio files. Also in preferred embodiments, the filtered content may be void of advertisements from the web page or content address, formatting commands, and/or user comments on the content.

In some embodiments, the filtered content from the Signature Based Scrubbing Engine 324 may be sent or otherwise made available to the Web Content Converter Module 323, the Request Polling Engine 321, the Hyperlink Association Engine 325, and/or the Image Association Engine 326. In other embodiments, filtered content from the Signature Based Scrubbing Engine 324 may be stored in a database on a data store 308 accessible by the Request Polling Engine 321, the Web Content Retrieval Engine 322, the Web Content Converter Module 323, the Hyperlink Association Engine 325, and/or the Image Association Engine 326.

The Hyperlink Association Engine 325 is configured to associate short code strings with hyperlinks found in unfiltered (i.e. raw) digital content. In preferred embodiments, the Hyperlink Association Engine 325 may associate a short code string in place of hyperlinks found in digital content created by the Signature Based Scrubbing Engine 324. In other embodiments, the Hyperlink Association Engine 325 may associate short code strings with hyperlinks contained in retrieved digital content from web pages and other digital content addresses retrieved by the Web Content Retrieval Engine 322. In some embodiments, the filtered content or the retrieved content may be sent or otherwise made available to the Hyperlink Association Engine 325 from a database accessible by the Request Polling Engine 321, the Web Content Retrieval Engine 322, the Web Content Converter Module 323, the Signature Based Scrubbing Engine 324, and/or the Image Association Engine 326.

Also in preferred embodiments, the Hyperlink Association Engine 325 may receive or otherwise be provided with access to the client device identification, the web page address or content address requested by the respective client device 400, the name of the web page or the name of the content address requested by the respective client device 400, the filtered content provided by the Signature Based Scrubbing Engine 324, the retrieved content provided by the Web Content Retrieval Engine 322, or to data stored by the Request Polling Engine 321, or data from the Web Content Retrieval Engine 322, the Web Content Converter Module 323, the Signature Based Scrubbing Engine 324, and/or the Image Association Engine 326 in a database on a data store 308.

Once the Hyperlink Association Engine 325 receives digital content retrieved for or filtered for a requesting client device 400, the Hyperlink Association Engine 325 may associate short code strings with hyperlinks contained in the digital content. The short code strings may preferably comprise one or more numbers, letters, and/or symbols that are associated with a particular hyperlink. In some embodiments, the short code strings are preferably consecutive in sequence starting with the first hyperlink that may be associated with a short code string in the first retrieved or filtered digital content requested by a particular client device 400.

For example, a particular client device 400 may request digital content comprising three hyperlinks. The short code strings “(1)”, “(2)”, and “(3)” may be associated, in order of occurrence, with the three hyperlinks in the digital content. A second request for digital content from the same client device 400 may be made for different digital content comprising four hyperlinks. The short code strings “(4)”, “(5)”, “(6)”, and “(7)” may be associated, in order of occurrence, with the four hyperlinks in the second requested digital content. This association may continue indefinitely with every subsequent hyperlink in the digital content being associated with a different short code string for a particular client device. Also in this example, the same short code strings may be used for different client devices 400, however, the associated hyperlinks may be different and correspond to the cumulative hyperlink history of each respective client device 400. The Hyperlink Association Engine 325 may store the short code strings and the associated hyperlinks for each client device 400 in a database on a data store 308 accessible by the Request Polling Engine 321, the Web Content Retrieval Engine 322, the Web Content Converter Module 323, the Signature Based Scrubbing Engine 324, and/or the Image Association Engine 326.

The Image Association Engine 326 is configured to associate short code strings with images, video files, audio files, and any other files embedded within or otherwise present in unfiltered digital content. In preferred embodiments, the Image Association Engine 326 may associate short code strings with images, hyperlinks, video files, audio files, and any other files contained in filtered digital content created by the Signature Based Scrubbing Engine 324. In other embodiments, the Image Association Engine 326 may associate short code strings with images, video files, audio files, and any other files contained in retrieved digital content from web pages and other digital content addresses retrieved by the Web Content Retrieval Engine 322. In some embodiments, the filtered content or the retrieved content may be sent or otherwise made available to the Image Association Engine 326 from a database on a data store 308 accessible by the Request Polling Engine 321, the Web Content Retrieval Engine 322, the Web Content Converter Module 323, the Signature Based Scrubbing Engine 324, and/or the Hyperlink Association Engine 325.

In some embodiments, the Image Association Engine 326 may be combined with the Hyperlink Association Engine 325. In digital content, both images and web pages may be specified as web addresses. For video files, the Image Association Engine 326 and/or the Hyperlink Association Engine 325 may be configured to send approximately one to fifty seconds and preferably thirty seconds of audio and/or video files as multimedia messages. In other embodiments, one or more modules or engines may be configured to trim or otherwise shorten the video/audio length of audio and video files that are longer than one to fifty seconds and preferably thirty seconds in length.

Also in preferred embodiments, the Image Association Engine 326 may receive or otherwise be provided with access to the client device identification, the web page address or content address requested by the respective client device 400, the name of the web page or the name of the content address requested by the respective client device 400, the filtered content provided by the Signature Based Scrubbing Engine 324, the retrieved content provided by the Web Content Retrieval Engine 322, or to data stored by the Request Polling Engine 321, the Web Content Retrieval Engine 322, the Web Content Converter Module 323, the, Signature Based Scrubbing Engine 324, and/or the Hyperlink Association Engine 325 in a database on a data store 308.

Once the Image Association Engine 326 receives digital content retrieved for or filtered for a requesting client device 400, the Image Association Engine 326 may associate short code strings with images, video files, audio files, and any other files contained in the digital content. The short code strings may preferably comprise one or more numbers, letters, and/or symbols that are associated with a particular image, video file, audio file, or other file. In some embodiments, the short code strings are preferably consecutive in sequence starting with the first image, video file, audio file, and other file that may be associated with a short code string in the first retrieved or filtered digital content requested by a particular client device 400.

For example, a particular client device may request digital content comprising two images and one video file. The short code strings “{1}”, “{2}”, and “{3}” may be associated, in order of occurrence, with the two images and one video file in the digital content. A second request for digital content may be made for different digital content comprising two images and two audio files. The short code strings “{4}”, “{5}”, “{6}”, and “{7}” may be associated, in order of occurrence, with the two images and two audio files in the second requested digital content. This association may continue indefinitely with every subsequent image, video file, audio file, and other file in the digital content being associated with a different short code string for a particular client device. Also in this example, the same short code strings may be used for different client devices 400, however, the associated images, video files, audio files, and other files may be different and correspond to the image, video file, audio file, and other file cumulative history of each respective client device 400. The Image Association Engine 326 may store the short code strings and the associated hyperlinks for each client device 400 in a database on a data store 308 accessible by the Request Polling Engine 321, the Web Content Retrieval Engine 322, the Web Content Converter Module 323, the Signature Based Scrubbing Engine 324, and/or the Hyperlink Association Engine 325.

Once the Image Association Engine 326 has associated short code strings with images, video files, audio files, and any other files contained in the retrieved or filtered digital content, and the Hyperlink Association Engine 325 has associated short code strings with hyperlinks contained in the digital content, the Web Content Converter Module 323 may remove the hyperlinks, images, video files, audio files, and any other files in the digital content while optionally retaining the text of the hyperlink or optionally retaining or inserting text identifying the images, video files, audio files, or any other files in the digital content. The Web Content Converter Module 323 may also be configured to substitute the short code string unique to a hyperlink, image, video file, audio file, or any other file and its respective client device into the digital content and then convert the digital content into a format such as email or any other format suitable for sending to a client device 400 over a data network 105 and the cellular carrier or service provider may convert the email or other format to a multimedia message (mms) to be delivered to a client device 400. For example, an email comprising digital content may be sent to mail 4081234567@mms.att.net. Because the receiving email address is dedicated for AT&T's MMS messages, the email message will be converted to a MMS message and sent to (408)123-4567 by AT&T.

In preferred embodiments, the Web Content Converter Module 323 may send a text message to a client device 400 (FIG. 1) comprising the text of the filtered digital content of a web page or content address with one or more short code strings associated with and substituted for any hyperlinks, images, video files, audio files, and any other files in the digital content of the web page or content address that was requested by the client device 400. In alternative preferred embodiments, the Web Content Converter Module 323 may send an email message to an email address associated with the client device 400 comprising the text of the digital content of a web page or content address with one or more short code strings associated with and substituted for any hyperlinks, images, video files, audio files, and any other files in the digital content of the web page or content address that was requested by the client device 400.

Turning now to FIG. 5, a table that illustrates an example of a Signature Lookup table 350 which may be used to organize or otherwise make signature patterns available to the Signature Based Scrubbing Engine 324 according to various embodiments is shown. Each content source may comprise a web page address (i.e. URL or domain), content address, or other web page or content identification. One or more signature patterns 352 which correspond to elements on a content source 351 such as a web page or content address may be associated with a content source 351. Digital content not contained in, located before/after a signature pattern 352 of the content source 351 may be removed or purged from the retrieved content by the Signature Based Scrubbing Engine 324. Similarly, digital content contained in, before/after a signature pattern 352 of a content source may be extracted from the retrieved content by the Signature Based Scrubbing Engine 324. Lookup table 310 may be stored in a database accessible by server 300. In some embodiments, Lookup table 310 may contain more than one signature pattern 352 for a content address 351. For example, a signature pattern 352 may include a starting signature pattern 352 and an ending signature pattern 352 with web content located in-between the starting pattern and ending pattern of the source (e.g. html) of the web content.

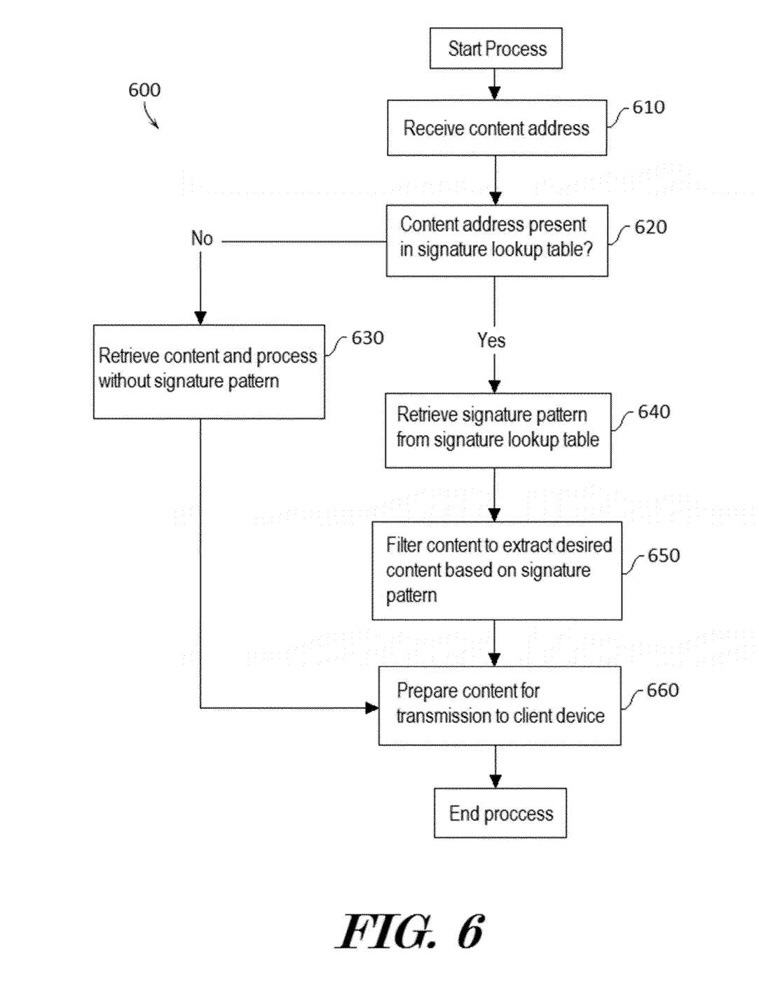

FIG. 6 depicts a flow chart that illustrates an example of a computer implemented process 600 for preparing digital content for transmission to a client device according to various embodiments. In this embodiment, the process 600 may be directed by a user 101 (FIG. 1) and be carried out through the input/output interfaces 404 (FIG. 3) on a client device 400. A user 101 (FIG. 1) may send a request for digital content from a content source such as a webpage or content address. The request may comprise a content address and optionally a short code string which may be associated with a content address of a hyperlink, image, video file, audio file, or any other file. The process 600 may start once a component of a server 300 receives a content address in step 610 which may be handled by Request Polling Engine 321. Next, the presence of the content address in a database such as a Signature Lookup Table 350 (FIG. 5) is determined in step 620 which may be handled by a Signature Based Scrubbing Engine 324. If the content address is not present in a Signature Lookup Table 350 (FIG. 5), the Web Content Retrieval Engine 322 may retrieve content and process without signature pattern in step 630 and then proceed to step 660. However, if content address present in a Signature Lookup Table 350 (FIG. 5), step 640 which comprises retrieving the signature pattern 352 (FIG. 5) of the content source 352 (FIG. 5) from the Signature Lookup Table 350 (FIG. 5). Next, in step 650 the content may be filtered to extract desired content based on signature pattern 352. Steps 640 and 650 may be handled by the Signature Based Scrubbing Engine 324. Finally, the content may be prepared for transmission to the requesting client device in step 660 which may be handled by the Web Content Converter Module 323. After step 660, the process 600 may end.

### Non-Limiting Example

Unfiltered web content may comprise an html webpage such as cnn.com/newsJUNE162014. Upon receiving a request for this webpage, the Signature Based Scrubbing Engine 324 may check the Signature Lookup Table 350 to determine if a signature pattern is present and any relevant rules for that content address 351. Based on rules and patterns stored by the system 100, the Signature Based Scrubbing Engine 324 is able to extract or prune desirable web content from the content source. Desirable web content may include a text news article while the entire page html source may include undesirable content such as advertisements and unrelated images or text data. As one example, desirable content may be located between a starting signature patter and an ending signature pattern. Signature patterns may be updated from time to time in the database by the system administrator or by a community of users.

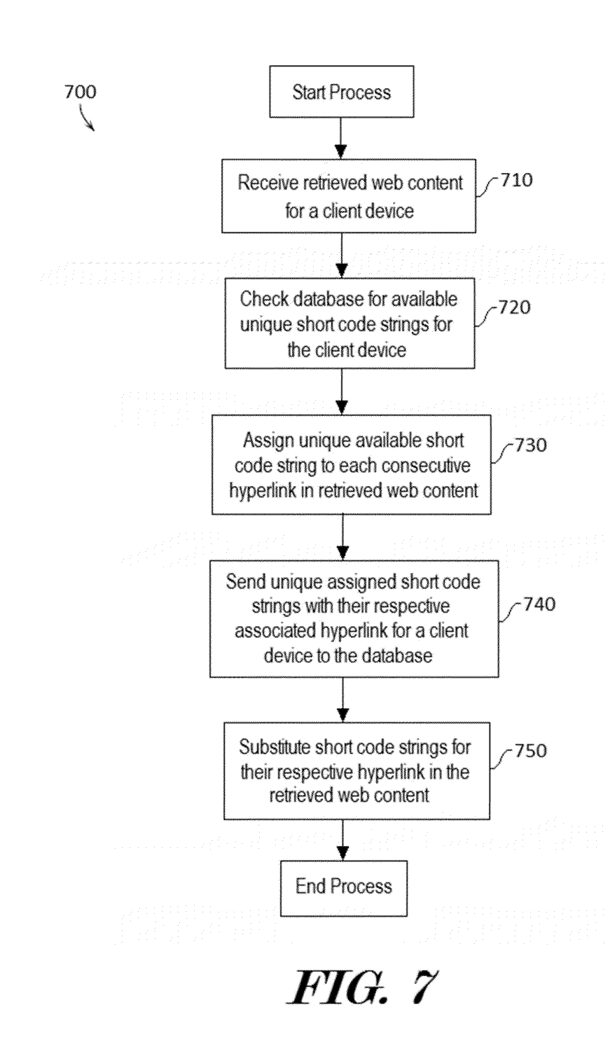

FIG. 7 depicts a flow chart that illustrates an example of a process 700 performed by a Hyperlink Association Engine 325 (FIG. 4) for associating a unique short code string to a hyperlink in the digital content from a content address or content source 351 (FIG. 5) requested by a client device. The process 700 may begin once the Hyperlink Association Engine 325 (FIG. 4) receives retrieved web content for a client device in step 710. In some embodiments, the retrieved web content may be provided by the Web Content Retrieval Engine 322 (FIG. 4). In further embodiments, the retrieved web content may comprise filtered content which may be provided by the Signature Based Scrubbing Engine 324 (FIG. 4). In step 720, the Hyperlink Association Engine 325 (FIG. 4) may check a database comprising the short code strings and their associated content addresses requested by the client device for the next available unique short code strings for the client device 720. In preferred embodiments, available unique short code strings may comprise the next sequential short code string that is not associated with a hyperlink content address out of the cumulative history of content addresses requested by the client device. In other embodiments, available unique short code strings may comprise any short code string that is not associated with a hyperlink content address out of the cumulative history of content addresses requested by the client device. In further embodiments, the short code strings may be recycled so that the oldest or least recently used short code string may be reassigned or associated with a different and preferably more recent hyperlink, image, video, audio, or other digital content. In step 730, a unique available short code string may be assigned to each consecutive hyperlink in the retrieved or filtered web content. Next, the unique assigned short code strings with their respective associated hyperlink content addresses for a client device may be sent to the database in step 740. Finally, in step 750, which may be handled by the Web Content Converter Module 323 comprising the Hyperlink Association Engine 325, the unique assigned short code strings may be substituted for their respective associated hyperlink in the retrieved web content. After step 750, the process 700 may end.

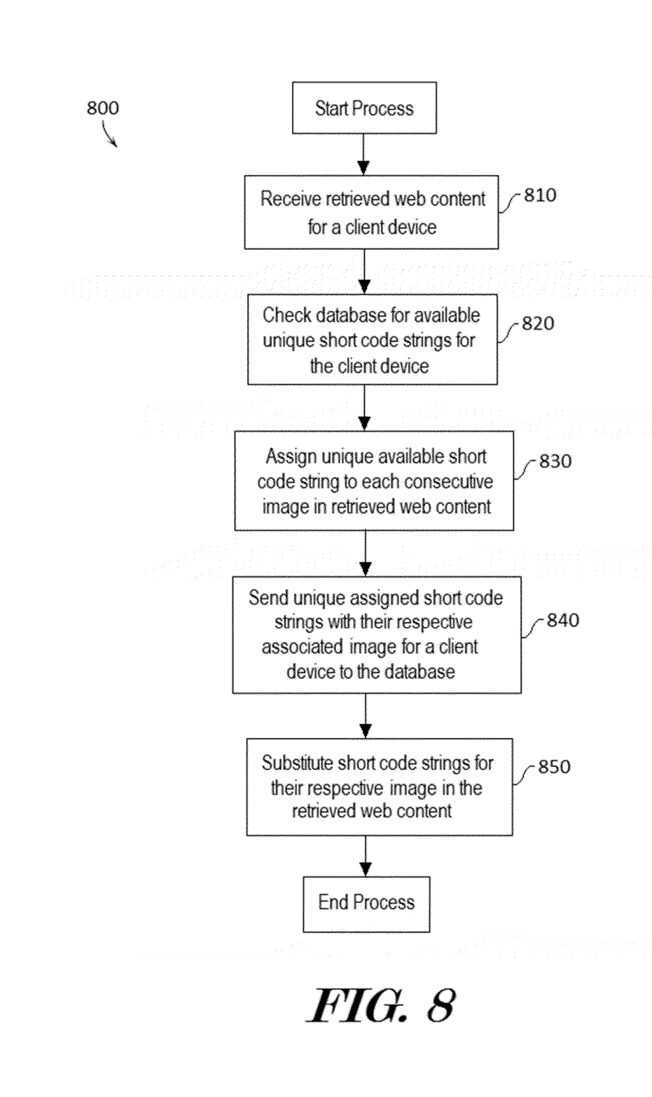

FIG. 8 depicts a flow chart that illustrates an example of a process 800 performed by an Image Association Engine 326 (FIG. 4) for associating a unique short code string to an image, video file, audio file, or other file in the digital content from a content address requested by a client device. The process 800 may begin once the Image Association Engine 326 (FIG. 4) receives retrieved web content for a client device in step 810. In some embodiments, the retrieved web content may be provided by the Web Content Retrieval Engine 322 (FIG. 4). In further embodiments, the retrieved web content may comprise filtered content which may be provided by the Signature Based Scrubbing Engine 324 (FIG. 4). In step 820, the Image Association Engine 326 (FIG. 4) may check a database comprising the short code strings and their associated content addresses requested by the client device for the next available unique short code strings for the client device 820. In preferred embodiments, available unique short code strings may comprise the next sequential short code string that is not associated with an image, video file, audio file, or other file of a content address out of the cumulative history of content addresses requested by the client device. In other embodiments, available unique short code strings may comprise any short code string that is not associated with an image, video file, audio file, or other file of a content address out of the cumulative history of content addresses requested by the client device. In further embodiments, the short code strings may be recycled so that the oldest or least recently used short code string may be reassigned or associated with a different and preferably more recent image, hyperlink, video, audio, or other digital content. In step 830, a unique available short code string may be assigned to each consecutive image in the retrieved or filtered web content. In other embodiments, a unique available short code string may be assigned to each consecutive video file, audio file, or other file in the retrieved or filtered web content. Next, the unique assigned short code strings with their respective associated hyperlink content addresses for a client device may be sent to the database in step 840. Finally, in step 850, which may be handled by the Web Content Converter Module 323 comprising the Image Association Engine 326, the unique assigned short code strings may be substituted for their respective associated image in the retrieved web content. In other embodiments, the unique assigned short code strings may be substituted for their respective associated video file, audio file, or other file in the retrieved web content. After step 850, the process 800 may end.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD) or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or wifi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device such as a personal digital assistant (PDA), laptop computer, or cellular telephone. The LAN communications network and the other communications networks such as cellular wireless and wifi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A computer implemented method to retrieve and send web content over a network, the method comprising using a server to:
(a) receive a request for web content from a client device over a network;
(b) retrieve unfiltered web content from a content provider;
(c) parse the unfiltered web content to create filtered web content; and
(d) transmit the filtered web content to the client device over a network through an electronic message.

2. The method of claim 1 wherein the network is a cellular network.

3. The method of claim 2 wherein the request for web content from a client device is transmitted as a message selected from a sms text message or a mms multimedia message.

4. The method of claim 3, wherein the web content is a web page formatted as html.

5. The method of claim 4, wherein the request for web content contains a url.

6. The method of claim 1, wherein the method further comprises assigning hyperlinks found in the retrieved unfiltered web content to a short code string where each short code string is unique to each hyperlink.

7. The method of claim 1, wherein the method further comprises assigning image files found in the retrieved unfiltered web content to a short code string where each short code string is unique to each image file.

8. The method of claim 6, wherein the method further comprises storing a list of short code strings, hyperlinks associated with said short code strings, and client device identification associated with a client device requesting web content in memory on a server.

9. The method of claim 8, wherein the client device identification is a phone number.

10. The method of claim 1, wherein the step of parsing the unfiltered web content to create filtered web content further comprises:
receiving a content address;
comparing content address to a signature lookup table;
searching web content html source for a signature pattern associated with the content address stored in the signature lookup table; and
extracting web content based on the location of the signature pattern within the web content html source.

11. A system to retrieve web content over a cellular network, the system comprising:
a. a request Polling engine, wherein the request Polling engine receives sms text message or mms multimedia message requests for web content retrieval from a client device;
b. a web page retrieval engine, wherein the web page retrieval engine retrieves web content from a content source;
c. a signature based scrubbing engine, wherein the signature based scrubbing engine filters web content from content source using a signature pattern;
d. a hyperlink association engine configured to replace hyperlinks found in web content with textual short code strings; and
wherein the signature based scrubbing engine and hyperlink association engine create a mms text message containing filtered web content capable of being received by a client device over a cellular network.
